(19) United States
(12) Patent Application Publication
(10) Pub. No.: US 2008/0121655 A1
(43) Pub. Date: May 29, 2008

(54) Dispensing systems and methods for liquid materials

(76) Inventors: William Schultz, Natick, MA (US); Stephen Schultz, Sharon, MA (US); Andrew Schultz, Sharon, MA (US); Ralph R. Hickman, Brecksville, OH (US); Xie Lei, Shanghai (CN); Wang Han, Shanghai (CN); Martin Izod, Glasgow (GB)

Correspondence Address: SCHACHT LAW OFFICE, INC., SUITE 202, 2801 MERIDIAN STREET, BELLINGHAM, WA, 98225-2412, US

(21) Appl. No.: 11/784,240

(22) Filed: Apr. 5, 2007

Related U.S. Application Data
(60) Provisional application No. 60/861,759, filed on Nov. 27, 2006.

(51) Int. Cl. B67D 5/56; B67D 5/40

(52) U.S. Cl. 222/129; 222/383.1

(57) ABSTRACT

A dispensing system for liquid materials comprising a container, a dispensing assembly, a cap member, and base material. The container defines a primary opening, a secondary opening, and a product chamber. The dispensing assembly is selectively attached to the container to cover the primary opening. The cap member is selectively attached to the container to cover the secondary opening. The base material is introduced into the product chamber through the secondary opening. The base material is dispensed from the product chamber through the primary opening using the dispensing assembly.

### RELATED APPLICATIONS

This application claims priority of U.S. Provisional Application Ser. No. 60/861,759 filed Nov. 27, 2006, the contents of which are incorporated herein by reference.

### TECHNICAL FIELD

The present invention relates to systems and methods for dispensing liquid materials and, more specifically, to such systems and methods that facilitate the formation of the liquid material at the point of dispensing.

### BACKGROUND OF THE INVENTION

Materials, such as cleaning preparations, are commonly sold in liquid form as part of a dispensing system comprising a container and a dispensing assembly. One common form of dispensing assembly comprises a pump handle that, when operated, dispenses liquid from within the container in the form of a spray.

When the container is empty of the material, the container is typically disposed of, and a new dispensing system is purchased. This process wastes what is typically still a perfectly functional dispensing container. In addition, the dispensing assembly is typically transported full of liquid. In some situations, the liquid material is water based, so the transportation of a full container assembly is expensive and wasteful.

The need thus exists for systems and methods for dispensing liquid materials such as cleaning preparations are less wasteful and expensive to transport.

### SUMMARY OF THE INVENTION

The present invention may be embodied as a dispensing system for liquid materials comprising a container, a dispensing assembly, a cap member, and base material. The container defines a primary opening, a secondary opening, and a product chamber. The dispensing assembly is selectively attached to the container to cover the primary opening. The cap member is selectively attached to the container to cover the secondary opening. The base material is introduced into the product chamber through the secondary opening. The base material is dispensed from the product chamber through the primary opening using the dispensing assembly.

### BRIEF DESCRIPTION OF THE DRAWINGS

FIG. 1 is a first side elevation view of a first example dispensing system constructed in accordance with, and embodying, the principles of the present invention;

FIG. 2 is a rear elevation view of the first example dispensing system;

FIG. 3 is a section view depicting an example storage compartment of the first example dispensing system taken along lines 3-3 in FIG. 1;

FIG. 4 is a partial side elevation view depicting an additive material storage compartment defined by the first example dispensing system and illustrating additive material extraction steps of an example method of the present invention;

FIG. 5 is a section view of the first example dispensing system, taken along lines 5-5 in FIG. 2, illustrating a liquid material adding step of an example method of the present invention;

FIG. 6 is a section view similar to FIG. 5 depicting an additive material insertion step of an example method of the present invention;

FIG. 7 is a section view similar to FIG. 5 depicting a mixing step of an example method of the present invention;

FIG. 8 is a side elevation view of the first example dispensing system depicting a dispensing step of an example method of the present invention;

FIG. 9 is a section view similar to that of FIG. 3 depicting an example storage compartment of a second example dispensing system of the present invention;

FIG. 10 is a section view similar to that of FIG. 3 depicting an example storage compartment of a third example dispensing system of the present invention;

FIG. 11 is a front elevation view of a first example additive material package that may be used in conjunction with the example dispensing system and methods of the present invention;

FIG. 12 is a section view taken along lines 12-12 in FIG. 11 depicting the removal of example additive material from the first example additive material package;

FIG. 13 is a front elevation view of a second example additive material package that may be used in conjunction with the example dispensing system and methods of the present invention;

FIG. 14 is a second side elevation view of the first example dispensing system;

FIG. 15 is a front elevation view of the first example dispensing system;

FIG. 16 is a top plan view of the first example dispensing system;

FIG. 17 is a bottom plan view of the first example dispensing system;

FIG. 18 is a first side elevation view of a second example dispensing system constructed in accordance with, and embodying, the principles of the present invention;

FIG. 19 is a rear elevation view of the second example dispensing system;

FIG. 20 is a second side elevation view of the second example dispensing system;

FIG. 21 is a front elevation view of the second example dispensing system;

FIG. 22 is a top plan view of the second example dispensing system;

FIG. 23 is a bottom plan view of the second example dispensing system;

FIG. 24 is a first side elevation view of a third example dispensing system constructed in accordance with, and embodying, the principles of the present invention;

FIG. 25 is a rear elevation view of the third example dispensing system;

FIG. 26 is a second side elevation view of the third example dispensing system;

FIG. 27 is a front elevation view of the third example dispensing system;

FIG. 28 is a top plan view of the third example dispensing system;

FIG. 29 is a bottom plan view of the third example dispensing system;

FIG. 30 is a first side elevation view of a fourth example dispensing system constructed in accordance with, and embodying, the principles of the present invention;

FIG. 31 is a rear elevation view of the fourth example dispensing system;

FIG. 32 is a second side elevation view of the fourth example dispensing system;

FIG. 33 is a front elevation view of the fourth example dispensing system;

FIG. 34 is a top plan view of the fourth example dispensing system;

FIG. 35 is a bottom plan view of the fourth example dispensing system;

FIG. 36 is a first side elevation view of a fifth example dispensing system constructed in accordance with, and embodying, the principles of the present invention;

FIG. 37 is a rear elevation view of the fifth example dispensing system;

FIG. 38 is a second side elevation view of the fifth example dispensing system;

FIG. 39 is a front elevation view of the fifth example dispensing system;

FIG. 40 is a top plan view of the fifth example dispensing system;

FIG. 41 is a bottom plan view of the fifth example dispensing system;

FIG. 42 is a first side elevation view of a sixth example dispensing system constructed in accordance with, and embodying, the principles of the present invention;

FIG. 43 is a rear elevation view of the sixth example dispensing system;

FIG. 44 is a second side elevation view of the sixth example dispensing system;

FIG. 45 is a front elevation view of the sixth example dispensing system;

FIG. 46 is a top plan view of the sixth example dispensing system;

FIG. 47 is a bottom plan view of the sixth example dispensing system;

FIG. 48 is a cutaway view taken along lines 48-48 in FIG. 52;

FIG. 49 is a plan view of a top ply used by a cover member of the sixth example dispensing system;

FIG. 50 is a plan view of a bottom ply used by the cover member of the sixth example dispensing system; and

FIG. 51 is a partial front elevation view similar to FIG. 42 illustrating the cover member of the sixth example dispensing system in a second, or open, configuration.

### DETAILED DESCRIPTION OF THE INVENTION

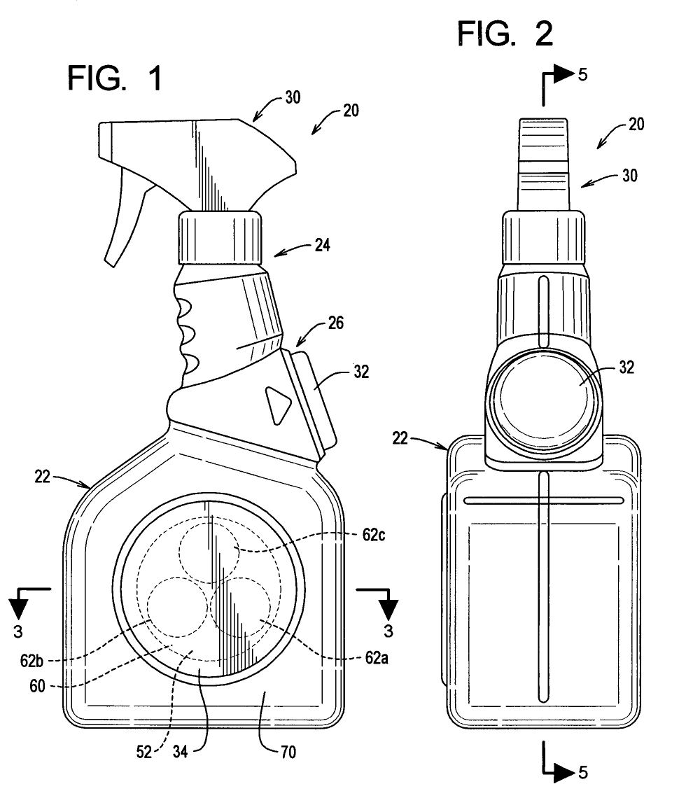

Referring initially to FIG. 1 of the drawing, depicted at 20 therein is a first example dispensing system constructed in accordance with, and embodying, the principles of the present invention. The dispensing system 20 comprises a container 22 defining a primary opening 24 and a secondary opening 26. The first example dispensing system 20 further comprises a dispensing assembly 30, a cap member 32, and a cover member 34.

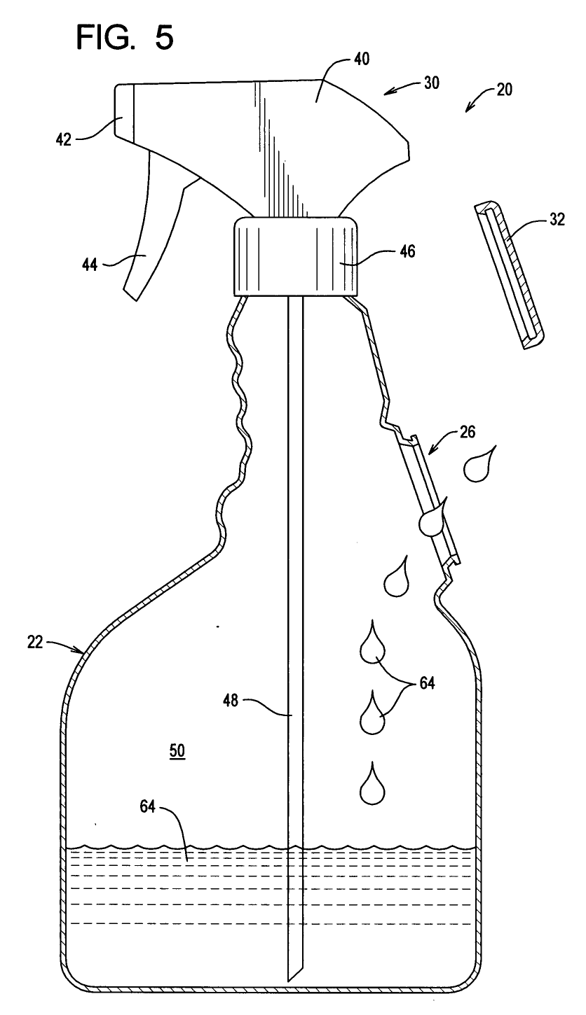

As perhaps best shown in FIGS. 5-7, the dispensing assembly 30 comprises a base portion 40, a nozzle member 42, a lever member 44, a collar member 46, and a dip tube 48 and is or may be a conventional pump spray assembly. The collar member 46 detachably attaches the dispensing assembly 30 to the container 22 at the primary opening 24. The dip tube 48 extends from the base portion 40 to a bottom of a container chamber 50 defined by the container 22.

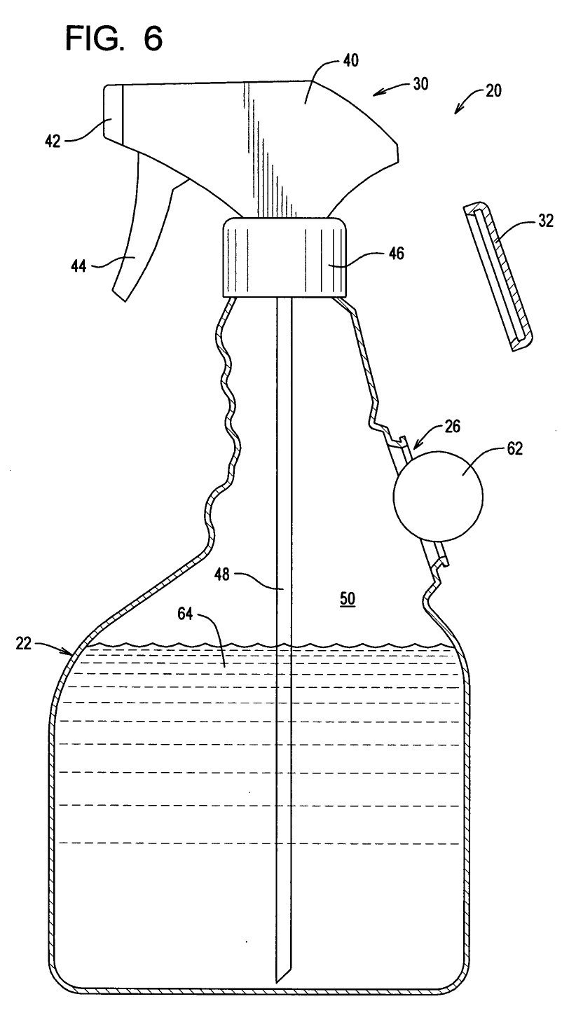

The cap member 32 may be detachably attached to the secondary opening 26. In a first cap configuration as shown in FIGS. 1, 2, 7, and 8, the cap member 32 is attached to the secondary opening 26 substantially to prevent flow of fluids into the container chamber 50 through the secondary opening 26. In a second cap configuration as shown in FIGS. 5 and 6, the cap member 32 is detached from the secondary opening 26 such that fluids may be introduced into the container chamber 50 through the secondary opening 26.

The cover member 34 may be detachably attached to the container 22. In a first cover configuration as shown in FIGS. 1-3, the cover member 34 engages the container 22 to at least partly extend over an additive material cavity 52. In a second cover configuration as shown in FIG. 4, the cover member 34 is at least partly removed from the container 22 to allow access to the additive material cavity 52.

As shown by broken lines in FIG. 1, the example dispensing system 20 further comprises an additive material package 60 comprising first, second, and third additive material tablets 62a, 62b, and 62c. The additive material package 60 containing the additive material tablets 62 is sized and dimensioned to fit within the additive material cavity 52.

The first example dispensing system 20 is constructed and used as follows. Initially, the container 22, dispensing assembly 30, cap member 32, cover member 34, and additive package 60 (containing additive material) are manufactured. The dispensing assembly 30 is attached to the primary opening 24, and the cap member 32 is attached to the secondary opening 26. The additive package 60 is placed into the additive material cavity 52. The cover member 34 is then attached to the container 22 so that the additive package 60 is constrained within the additive material cavity 52.

At this point, the dispensing system 20 is in what will be referred to as a transportation configuration, which is shown in FIG. 1. The dispensing system 20 in the transportation configuration is transported to the point of use.

At the point of use, the cover member 34 is detached from the container 22 to expose the additive package 60 within the additive material cavity 52 as shown in FIG. 4. The additive material package 60 is then removed from the additive material cavity 52. Additive material, in this case one of the additive material tablets 62, is removed from the additive material package 60 as shown in FIG. 12.

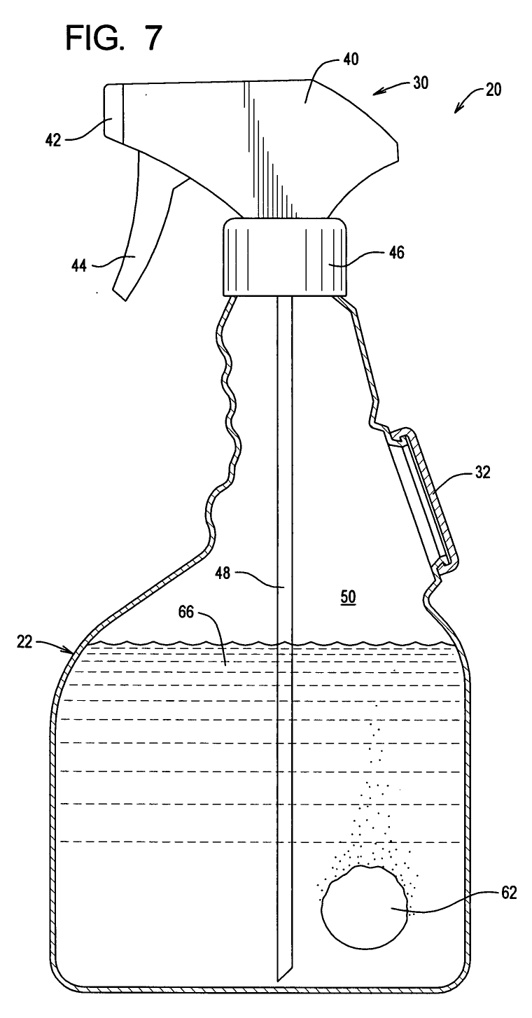

The cap member 32 is detached from the container 22 such that base liquid 64, such as water, and the additive material tablet 62 may be introduced into the container chamber 50 through the secondary opening 26 as shown in FIGS. 5 and 6. The additive material in the form of the additive material tablet 62 mixes with the base liquid 64 as shown in FIG. 7 to form a final mixture 66.

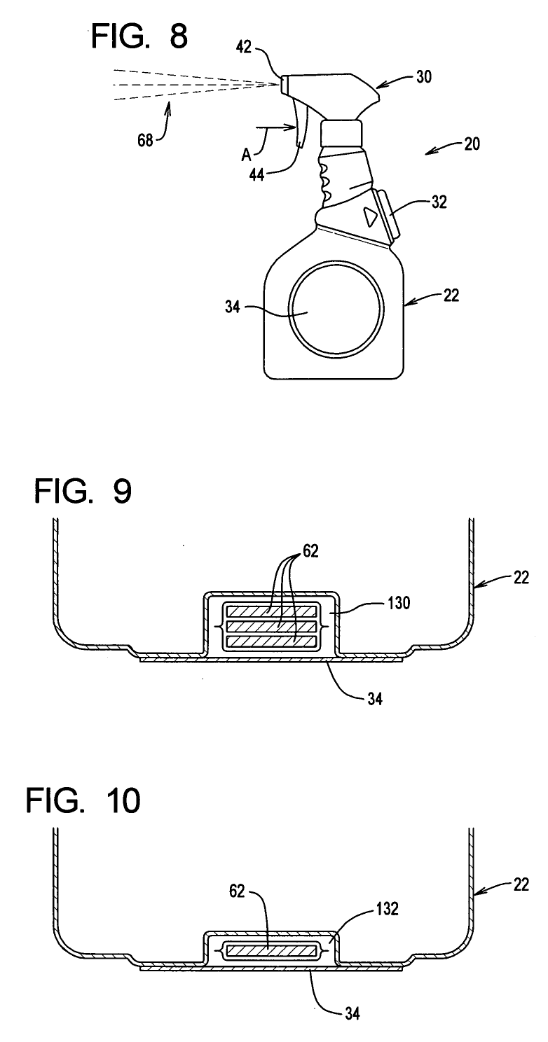

At this point, the dispensing system 20 is in what will be referred to as a dispensing configuration as shown in FIG. 8. With the dispensing system in the dispensing configuration, the lever member 44 is displaced in the direction shown by arrow A in FIG. 8 to pump the final mixture 66 from within the container 22 through the dip tube 48 and out of the nozzle member 42 in the form of a spray 68.

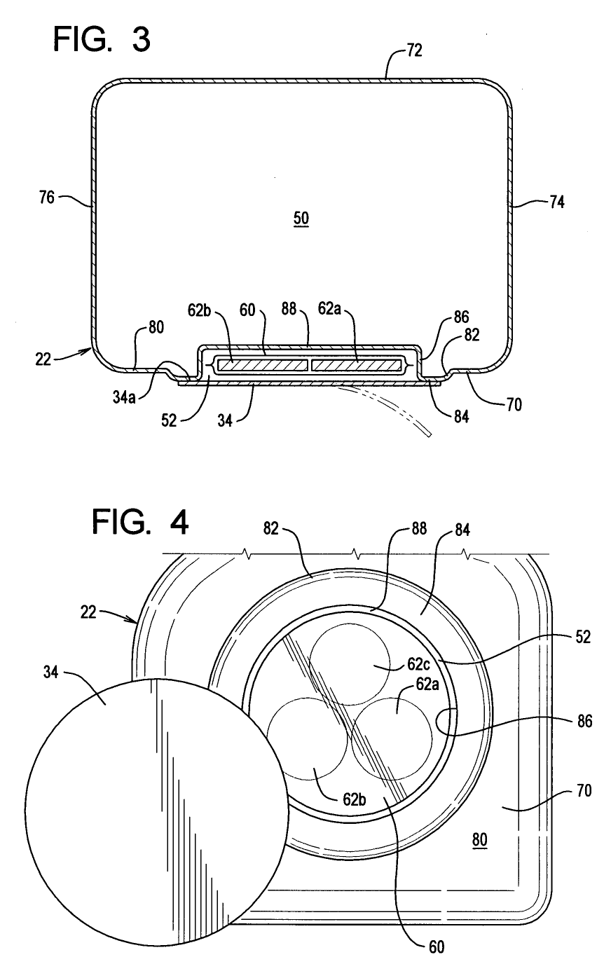

The details of construction of the example dispensing system 20 will now be described in further detail. As shown in FIG. 1, 3, and 4, the container 22 defines first and second side panels 70 and 72 and first and second end panels 74 and 76. As perhaps best shown in FIG. 3, the first side panel 70 comprises a main portion 80, a first bridge portion 82, an attachment portion 84, a second bridge portion 86, and a recessed portion 88. The second bridge portion 86 and the recessed portion 88 define the additive material cavity 52.

Adhesive material is applied to at least a portion of an inner surface 34a of the cover member 34. To place the cover member 34 in the first cover member configuration, a portion of the inner surface 34a is then brought into contact with the attachment portion 84 of the first side panel 70. At this point, the cover member 34 is in the first cover configuration and extends at least partly over the additive material cavity 52.

The adhesive on the inner surface 34a is configured to facilitate removal of the cover member 34 when desired. For example, adhesive material may be applied only to a portion of the inner surface 34a in contact with the side panel attachment portion 84. Accordingly, to place the example cover member 34 into the second cover configuration, the portion of the cover member 34 that is not adhered to the side panel attachment portion 84 may initially be peeled away from the attachment portion 84. The user then has grip to facilitate removal of at least an additional portion of the cover member 34 from the side panel attachment portion 84. The cover member 34 is thus detachably attachable to the container 22 to allow selective access to the additive material cavity 52.

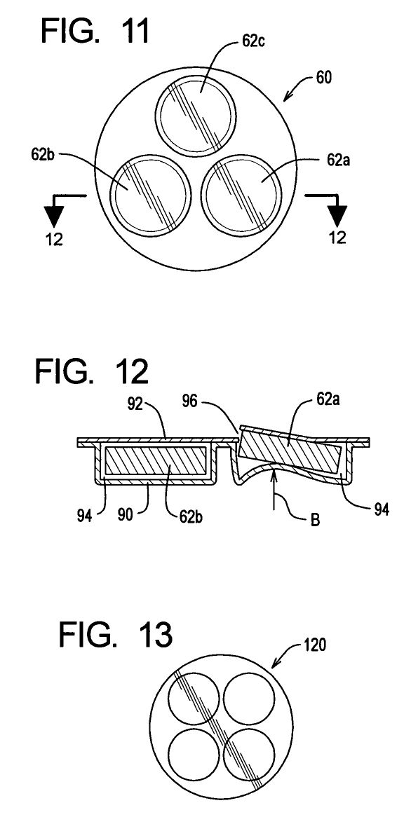

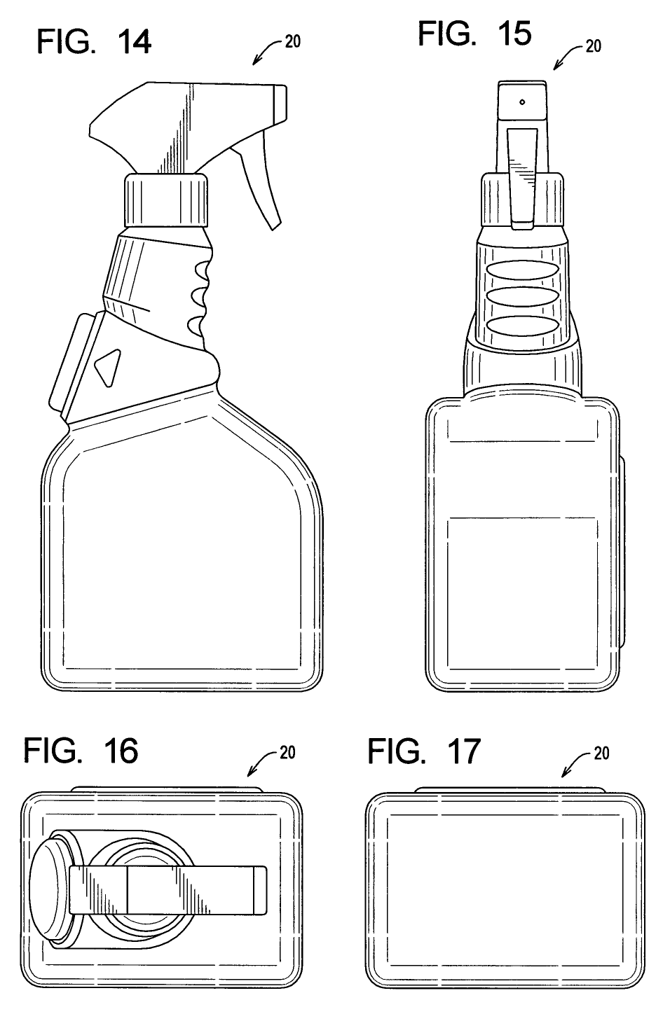

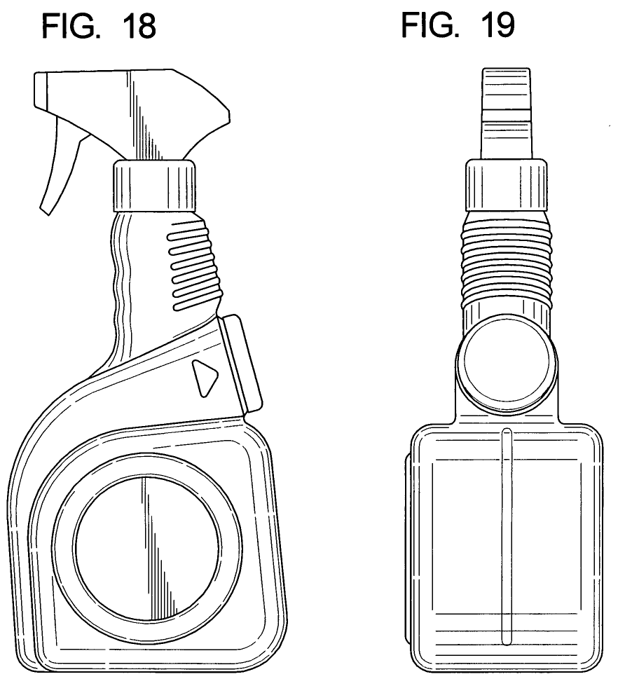

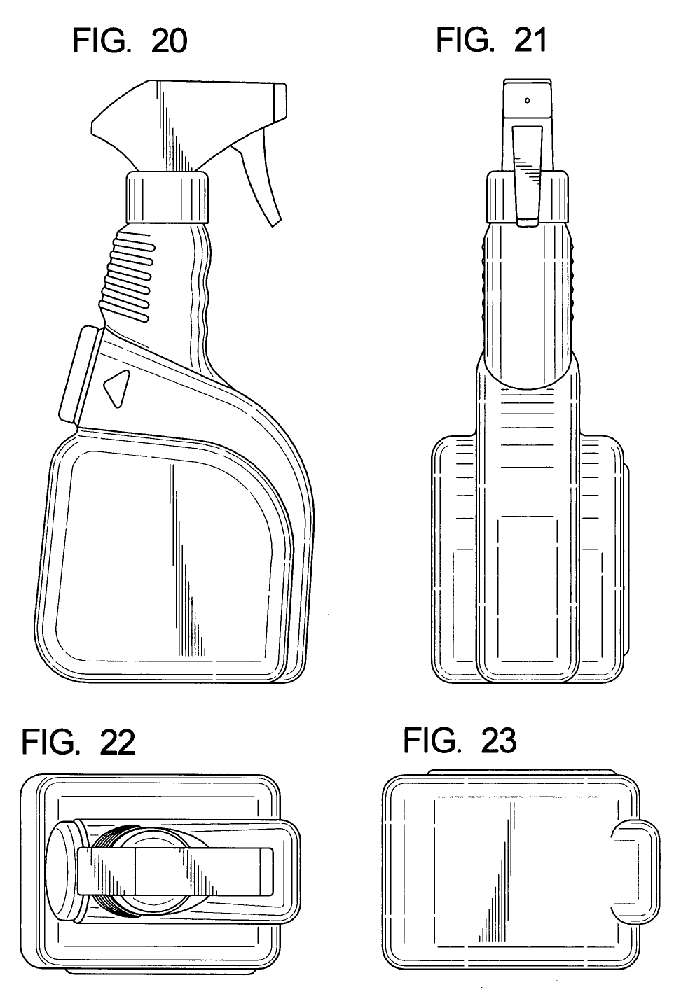

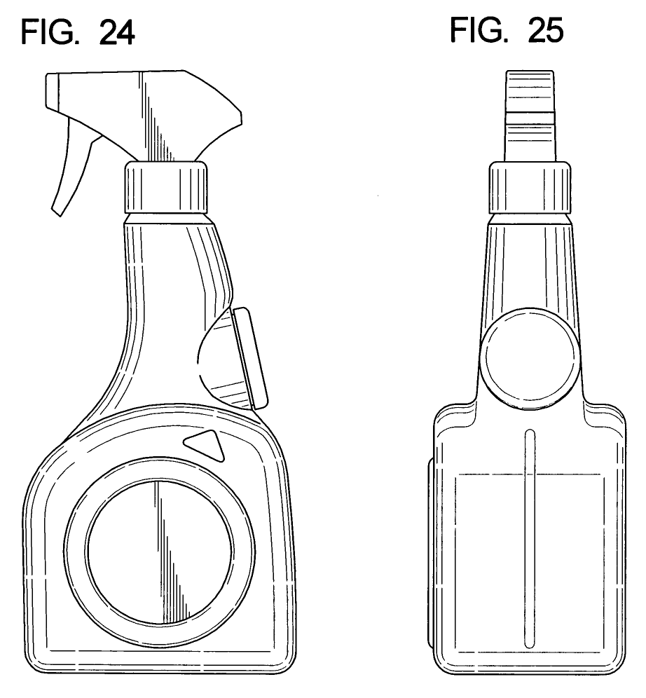

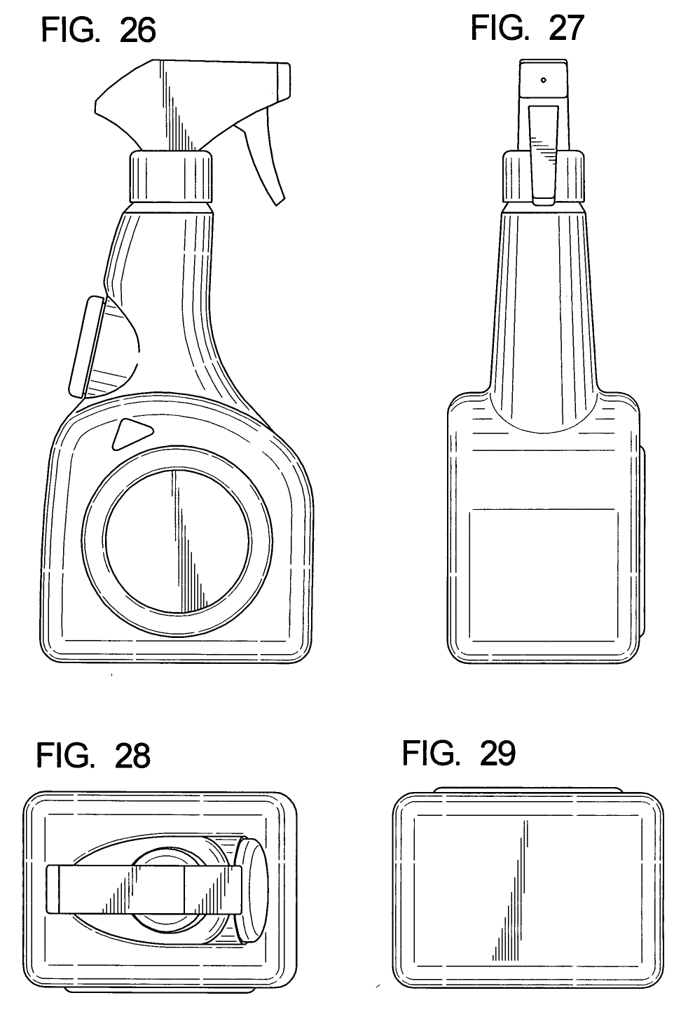

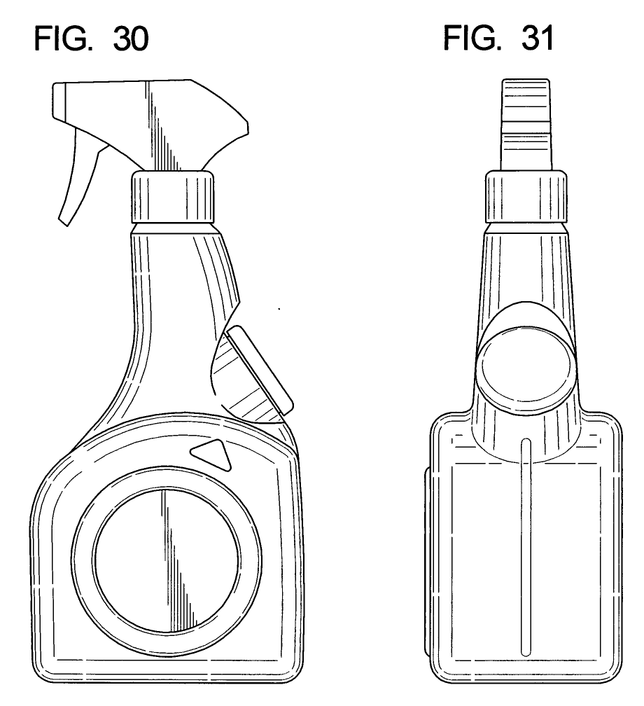

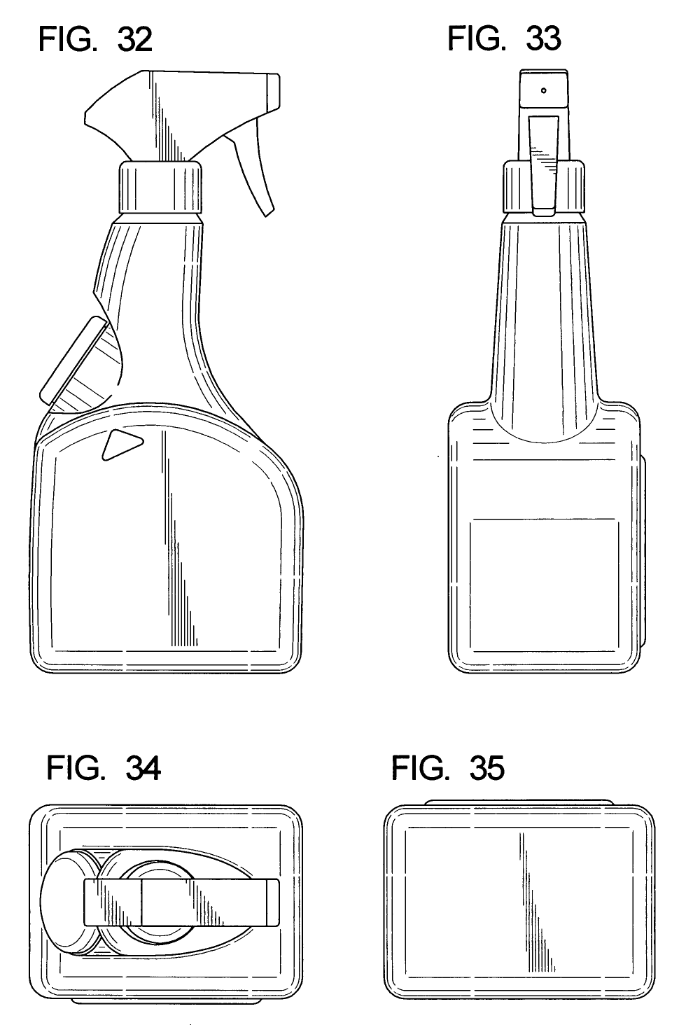

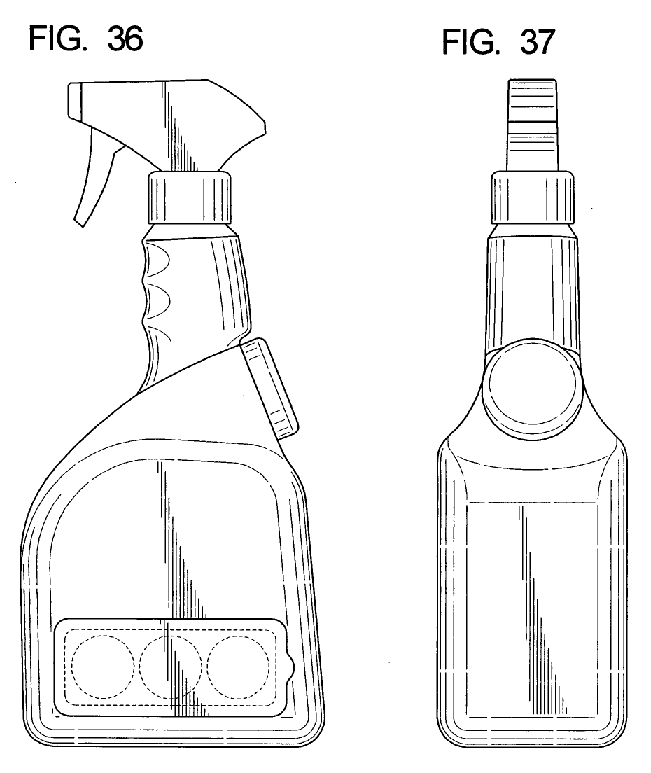

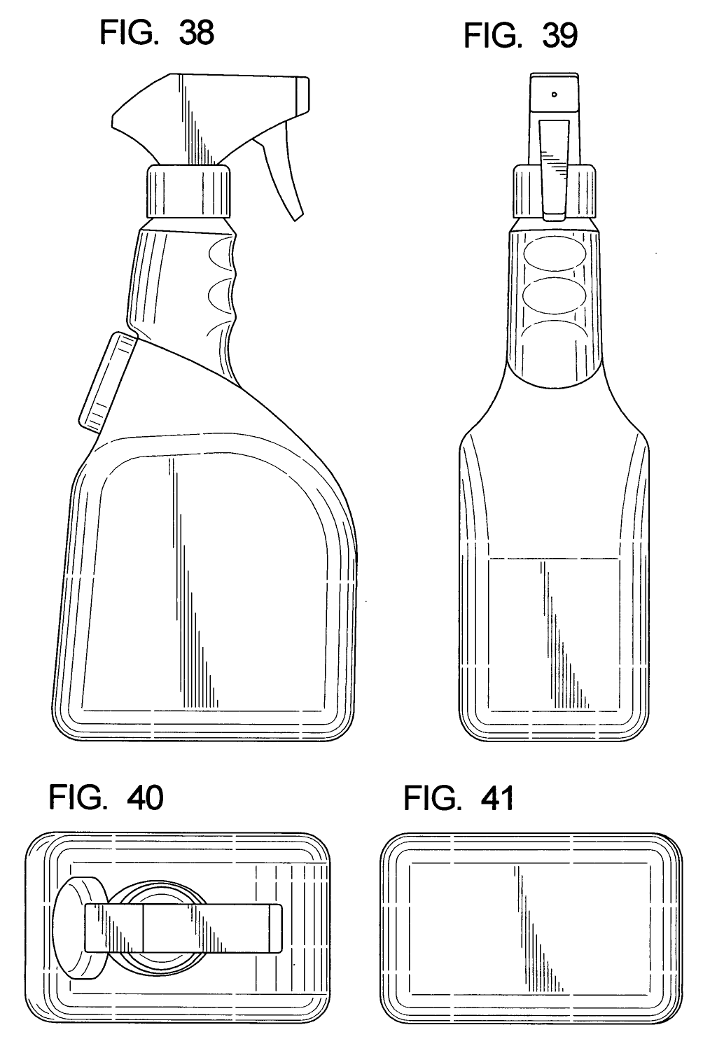

Once the cover member 34 is in the second cover configuration, the additive material package 60 may be removed from the additive material cavity 52. FIGS. 11 and 12 illustrate that the example additive material package 60 comprises a first sheet 90 and a second sheet 92. The example first sheet 90 is made of plastic molded to define pockets 94 sized and dimensioned to accommodate the example additive material tablets 62. The example second sheet 92 is adhered to first sheet 90 such that the pockets 94 are substantially sealed.

To remove the tablet 62a from the sealed pockets 94, a force is applied to the first sheet 90 in the direction of arrow B in FIG. 12 to cause an edge of the tablet 62a to form a tear 96 in the second sheet 92. The tablet 62a may then be pushed through the tear 96 in the second sheet 92.

Once the tablet 62a has been removed from the additive material package 60, the additive material package 60 with the remaining tablets 62b and 62c therein may be placed back into the additive material cavity 52 and the cover member 34 may be returned to the first configuration. The tablets 62b and 62c may thus be stored for later use in substantially the same manner as the tablet 62a.

The example additive material cavity 52 is circular in shape as shown in FIGS. 1 and 4; the example additive material package 60 is also circular in shape, and is sized and dimensioned to fit within the additive material cavity 52 as described herein. However, the additive material cavity 52 and/or additive material package 60 may be embodied using other shapes. One or both of these may be square, triangular, or other more fanciful shapes depending upon the particular environment in which the dispensing system 20 will be used. FIG. 13 further illustrates an additive material package 120 that is circular and contains more than three, in this case four, tablets.

In addition, the example additive material cavity 52 is sized and dimensioned to hold three tablets 62 in a single, side-by-side layer, with each tablet independently contained. FIG. 9 depicts an alternative additive material cavity 130 that is sized and dimensioned to hold three of the tablets 62 in a stacked configuration. FIG. 10 depicts yet another additive material cavity 132 that is sized and dimensioned to contain a single independently wrapped tablet 62.

In addition to different shapes and depths, the additive material cavity may be located in different panels of the container 22 or, possibly, on one or both of the dispensing assembly 30 and the cap member 32. In addition, more than one additive material cavity may be provided on a single container.

As yet another alternative, the container of the present invention may be formed without an additive material cavity. In this case, the additive material package 60 will extend from a panel of the container. The additive material package may be held in place relative to the container by a cover member such as the cover member 34 defined above.

Whether or not an additive material cavity is used, the additive material package may be adhered directly to the container without use of a separate cover member. In this case, an adhesive may be applied to a surface of the additive material package to hold the additive material package in place relative to the container.

In addition, while the examples depicted above depict the use of dry additive material in the form of a tablet, other additive materials may be provided in liquid form and contained within one or more pouches (similar to that used to dispense restaurant condiments) that are held in place relative to the container using any of the methods described above.

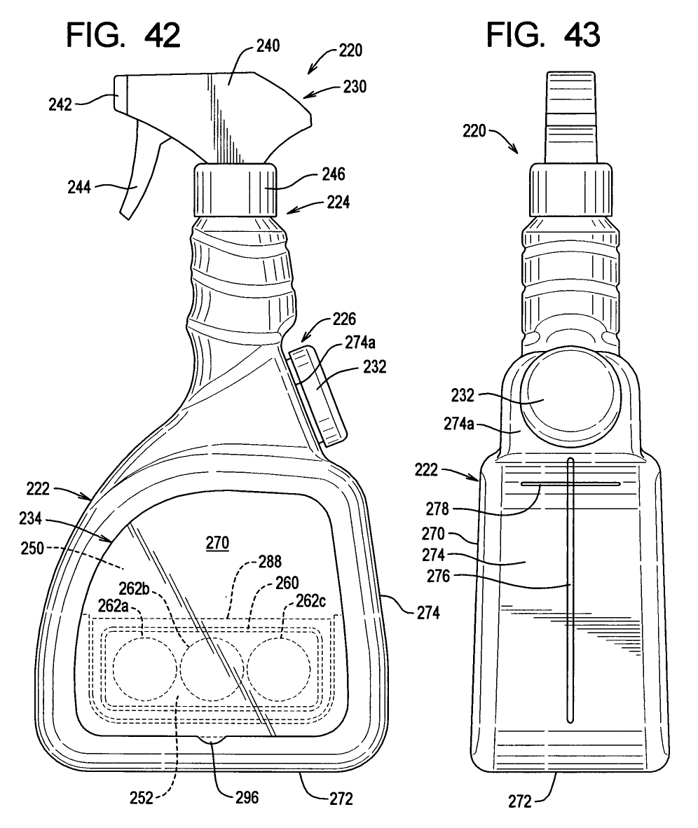

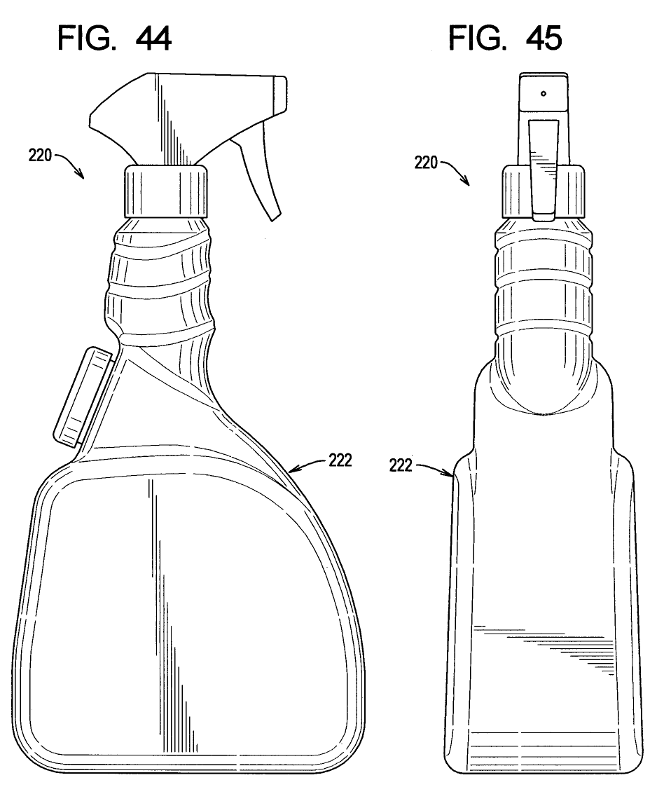

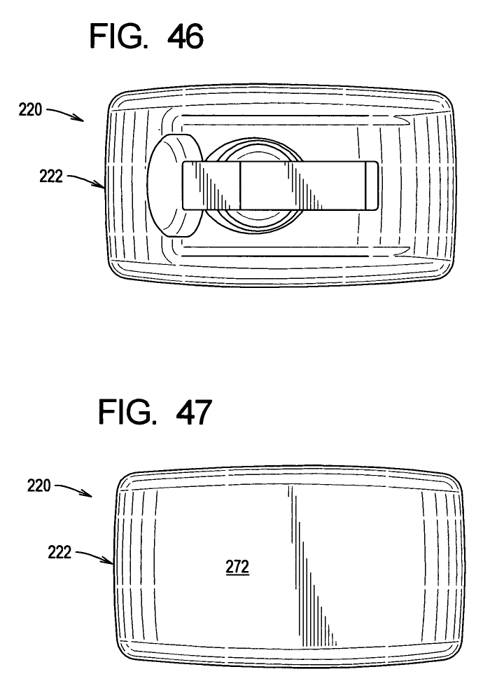

Referring now to FIGS. 42-46 of the drawing, depicted at 220 therein is a sixth example dispensing system constructed in accordance with, and embodying, the principles of the present invention. The dispensing system 220 comprises a container 222 defining a primary opening 224 and a secondary opening 226. The first example dispensing system 220 further comprises a dispensing assembly 230, a cap member 232, and a cover member 234.

The dispensing assembly 230 comprises a base portion 240, a nozzle member 242, a lever member 244, a collar member 246, and a dip tube (not shown) and is or may be a conventional pump spray assembly. The collar member 246 detachably attaches the dispensing assembly 230 to the container 222 at the primary opening 224. The dip tube extends from the base portion 240 to a bottom of a container chamber 250 defined by the container 222.

The cap member 232 may be detachably attached to the secondary opening 226. When attached to the secondary opening 226, the cap member 232 substantially prevents flow of fluids into or out of the container chamber 250 through the secondary opening 226. In a second cap configuration, the cap member 232 is detached from the secondary opening 226 such that fluids may be introduced into the container chamber 250 through the secondary opening 226.

The example cover member 234 also may be at least partly detachably attached to the container 222. In a first cover configuration (FIG. 42), the cover member 234 engages the container 222 to at least partly extend over an additive material cavity 252. In a second cover configuration (FIG. 51), the cover member 234 is partly removed from the container 222 to allow access to the additive material cavity 252.

As shown by broken lines in FIG. 42, the example dispensing system 220 further comprises an additive material package 260 comprising first, second, and third additive material tablets 262a, 262b, and 262c. The additive material package 260 containing the additive material tablets 262 is sized and dimensioned to fit within the additive material cavity 252.

The sixth example dispensing system 220 is constructed and used as follows. Initially, the container 222, dispensing assembly 230, cap member 232, cover member 234, and additive package 260 (containing additive material) are manufactured. The dispensing assembly 230 is attached to the primary opening 224, and the cap member 232 is attached to the secondary opening 226. The additive package 260 is placed into the additive material cavity 252. The cover member 234 is then attached to the container 222 so that the additive package 260 is constrained within the additive material cavity 252. At this point, the dispensing system 220 is in what will be referred to as a transportation configuration during which he dispensing system 220 is transported to the point of use.

At the point of use, the cover member 234 is detached from the container 222 to expose the additive package 260 within the additive material cavity 252. The additive material package 260 is then removed from the additive material cavity 252. Additive material, in this case one of the additive material tablets 262, is removed from the additive material package 260.

The cap member 232 is detached from the container 222 such that base liquid, such as water, and the additive material tablet 262 may be introduced into the container chamber 250 through the secondary opening 226. The additive material in the form of the additive material tablet 262 mixes with the base liquid to form a final mixture.

At this point, the dispensing system 220 is in what will be referred to as a dispensing configuration. With the dispensing system in the dispensing configuration, the lever member 244 is displaced to pump the final mixture from within the container 222 through a dip tube and out of the nozzle member 242.

After one or more of the additive material tablets 262 have been used, any remaining additive material tablets 262 may be placed back into the additive material cavity 252 for storage until the dispensing assembly is to be used again.

The example additive material cavity 252 is rectangular in shape as shown in FIG. 42; the example additive material package 260 is also rectangular in shape, and is sized and dimensioned to fit within the additive material cavity 252 as described herein. However, the additive material cavity 252 and/or additive material package 260 may be embodied using other shapes. One or both of these may be square, triangular, or other more fanciful shapes depending upon the particular environment in which the dispensing system 220 will be used.

The container 222 of the example dispensing system 220 comprises at least a first side panel 270, a bottom panel 272, and a rear panel 274. The additive material cavity 252 is formed in the first side panel 270, while the secondary opening 226 is formed in an upper portion 274a of the rear panel 274. As shown in FIG. 43 of the drawing, a window strip 276 and a level line 278 are formed on the rear panel 274.

The container 222 is in an upright position as shown, for example, in FIGS. 42 and 43. In this upright position, a reference plane defined by the bottom panel 272 is substantially horizontal.

When the container 222 is in the upright position, the rear panel upper portion 274a is above the level line 278. In addition, the rear panel upper portion 274a is angled with respect to the reference plane defined by the bottom panel 272. In particular, when the container is in the upright position, the reference plane defined by the bottom panel 272 is substantially horizontal, and the rear panel upper portion 274a extends at an angle of approximately seventy degrees with respect to horizontal. This angle is preferably substantially within a first preferred range of approximately sixty-eight to seventy-two degrees and in any event should be substantially within a second preferred range of approximately sixty-five to seventy-five degrees.

The secondary opening 226 is formed in the rear panel upper portion 274a. In the example dispensing system 220, the secondary opening 226 is a circular opening having a diameter of approximately thirty-eight millimeters. The diameter of the secondary opening 226 is preferably substantially within a first preferred range of approximately thirty-five to forty-one millimeters and in any event should be substantially within a second preferred range of approximately thirty-three to forty-three millimeters.

The angle of the rear panel upper portion 274a and the area of the secondary opening 226 are such that liquid may be introduced into the container chamber 250 through the secondary opening 226 without substantially moving the container 222 from the upright position.

The window strip 276 is integrally formed with the rear panel 274 of material that allows at least a level of any liquid material within the chamber 250 to be determined from outside of the container 222. The level line 278 identifies a full level for purposes of determining how much water to mix with one of the additive material tablets 262. In the example dispensing system 220, when the liquid within the container 222 reaches the level line 278 as viewed through the window strip 276, the container 222 contains thirty-two ounces of liquid material.

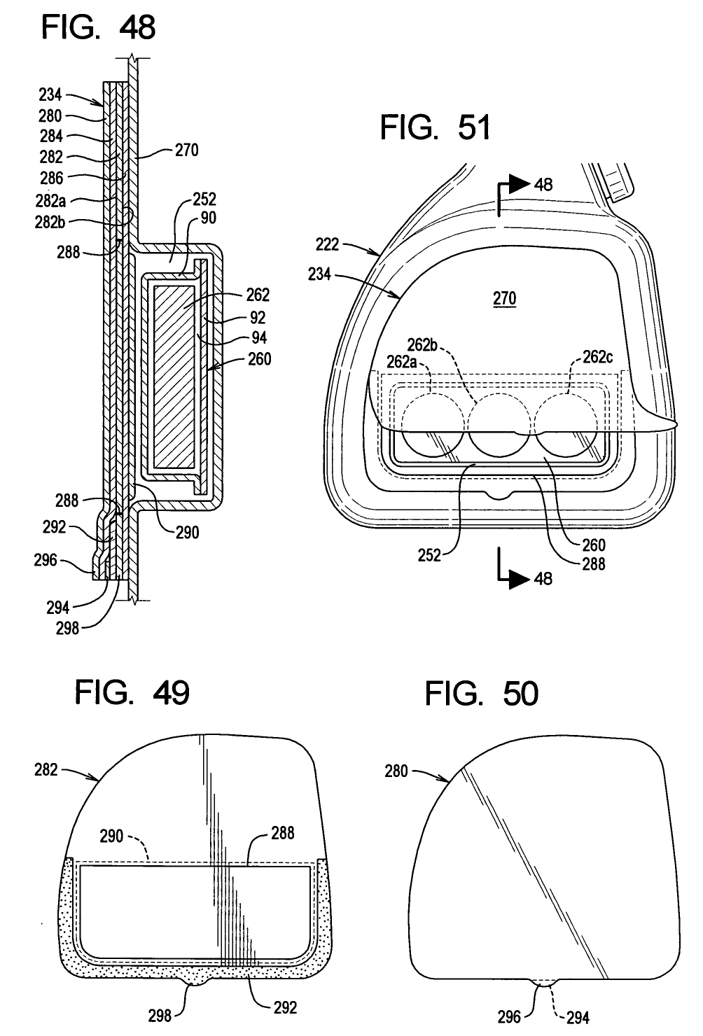

Turning now to FIGS. 48-50 of the drawings, the construction and operation of the example cover member 234 will now be described in further detail. The example cover member 234 takes the form of a label assembly that is applied to the first side panel 270. The label assembly forming the example cover member 234 comprises a top ply 280 and a bottom ply 282. An image is imprinted on at least a portion of an outer side 282a of the bottom ply 282, and the top ply 280 is preferably clear to allow the image to be viewed.

In addition, the top ply 280 is coated with a first layer of adhesive 284, while the bottom ply 282 is coated a second layer of adhesive 286. A score line 288 is formed in the bottom ply 282 as perhaps best shown in FIG. 49. The example score line 288 is a closed rectangle with rounded edges having substantially the same outline as that of the additive material cavity 252. The score line 288 allows a portion of the bottom ply 282 to move away from the additive material cavity 252 and a portion of the bottom ply 282 to remain in contact with the first side wall 270 when the cover member 234 is reconfigured from the first cover configuration to the second cover configuration.

FIGS. 49 and 50 show that the top and bottom plies 280 and 282 have the same shapes and dimensions, such that the top ply 280 completely overlies the bottom ply 282 when the example cover member 234 is formed. The shapes and dimensions of the top and bottom plies 280 and 282 need not be the same. In addition, although the use of two plies 280 and 282 may simplify the process of fabricating a cover member that allows selective access to the additive material cavity 252, such access may be obtained using a label comprising only one ply or structures other than a label.

FIG. 48 shows that an inner adhesive deadening layer 290 is formed on an inner side 282b of the bottom ply 282, while an outer adhesive deadening layer 292 is formed on the outer side 282a of the bottom ply 282. The example deadening layers 290 and 292 are formed by printing lacquer on the bottom ply 282.

The inner adhesive deadening layer 290 is applied over a region of the bottom ply inner side 282b as shown in FIG. 49 within the score line 288 to prevent the second adhesive layer 286 from bonding to the additive material package 260.

The outer adhesive deadening layer 292 is applied over a region of the bottom ply outer side 282a to allow the first adhesive layer 284 to detachably attach the top ply 280 to the bottom ply 282 around three sides of the additive material cavity 252. The region in which the outer adhesive deadening layer 292 is formed is substantially below the uppermost portion of the score line 288 when the container 222 is upright.

An opening strip 294 is arranged between a top tab portion 296 of the top ply 280 and a bottom tab portion 298 of the bottom ply 282. The opening strip 294 prevents the top tap portion 296 from adhering to the bottom tab portion 298 and thus facilitates the separation of the tab portions 296 and 298 to begin the process of reconfiguring the cover member 234 from its first cover configuration to its second cover configuration.

The example cover member 234 is placed from the first configuration into the second configuration as follows. Initially, the top tab portion 296 is pulled away from the bottom tab portion 298 to start separating the top ply 280 from the bottom ply 282. Continuing to pull the top tab portion 296 separates the top ply 280 from the container first side wall 270 in the region where the outside deadening layer 292 is formed. The portion of the bottom ply 282 within the score line 288 moves away from the additive material cavity 252 with the top ply 280, while the portion of the bottom ply 282 outside of the score line 288 separates from the top ply and stays in contact with the container first side wall 270.

To place the cover member 234 back into the first configuration, the bottom ply is brought back into contact with the outer adhesion deadening layer 292 around the side and bottom edges of the additive material chamber 252. The adhesion deadening layer 292 is formulated to allow sufficient adhesion to maintain the cover member 234 in the first configuration against inadvertent removal from the first side wall 270 but allows the cover member 234 to be placed into the second configuration by deliberate application of manual force.

FIG. 48 further shows that the example additive material package 260 may be constructed in the same manner as the additive material package described above with reference to FIG. 12. In this example package 260, the first sheet 90 is made of clear PVC to allow the tablets 262 to be viewed through the top ply 280, the bottom ply 282, and the first sheet 90. The second sheet 92 comprises a foil material capable of sealing the pockets 94 but also of splitting as shown in FIG. 12 to facilitate removal of the tablets 262.

Given the foregoing, it should be clear that the present invention may be embodied in forms other than those described and depicted herein. The scope of the invention should thus be determined by the claims appended hereto and not the foregoing discussion of example embodiments of the present invention.

What is claimed is:

1. A dispensing system for liquid materials comprising:
a container defining a primary opening, a secondary opening, and a product chamber;
a dispensing assembly adapted to be selectively attached to the container to cover the primary opening; and
a cap member adapted to be selectively attached to the container to cover the secondary opening; whereby
base material is introduced into the product chamber through the secondary opening; and
the base material is dispensed from the product chamber through the primary opening using the dispensing assembly.

2. A dispensing system as recited in claim 1, further comprising additive material inserted into the product chamber through the secondary opening, where the additive material is mixed with the base material in the product chamber to form a final mixture.

3. A dispensing system as recited in claim 2, in which at least one of the base material and the additive material is liquid.

4. A dispensing system as recited in claim 2, in which both of the base material and the additive material are liquid.

5. A dispensing system as recited in claim 2, in which at least one of the base material and the additive material is not liquid.

6. A dispensing system as recited in claim 2, in which:
the base material is liquid; and
the additive material is not liquid.

7. A dispensing system as recited in claim 1, in which the dispensing assembly is configured in a storage configuration in which the additive material is secured to the dispensing assembly outside of the product chamber.

8. A dispensing system as recited in claim 7, in which the container further defines an additive material cavity, where the additive material is within the additive material cavity when the dispensing assembly is in the storage configuration.

9. A dispensing system as recited in claim 8, further comprising a cover member for selectively covering the additive material cavity when the dispensing assembly is in the storage configuration.

10. A dispensing system as recited in claim 2, in which the additive material is contained within an additive material package when the dispensing system is in a storage configuration.

11. A dispensing system as recited in claim 2, in which the additive material is contained within an additive material package, and the additive material package is within the additive material cavity when the dispensing system is in a storage configuration.

12. A dispensing system as recited in claim 10, in which the additive material package contains a plurality of portions of additive material.

13. A dispensing system as recited in claim 10, in which the additive material package contains a plurality of tablets of additive material.

14. A dispensing system for liquid materials comprising:
a container defining a primary opening, a secondary opening, a product chamber, and an additive material cavity containing at least one portion of additive material;
a cover member that is detachably attached to the container to selectively cover the additive material cavity;
a dispensing assembly adapted to be selectively attached to the primary opening to cover the primary opening; and
a cap member adapted to be selectively attached to the secondary opening to cover the secondary opening; whereby
liquid base material and one portion of the additive material are introduced into the product chamber through the secondary opening to form a final liquid mixture; and
the final liquid mixture is dispensed from the product chamber through the primary opening using the dispensing assembly.

15. A dispensing system as recited in claim 14, in which both of the base material and the additive material are liquid.

16. A dispensing system as recited in claim 14, in which the additive material is not liquid.

17. A dispensing system as recited in claim 14, in which the at least one portion of the additive material is contained within an additive material package.

18. A dispensing system as recited in claim 14, in which the additive material package contains a plurality of tablets of additive material.

19. A method of dispensing liquid materials comprising the steps of:
providing a container defining a primary opening, a secondary opening, and a product chamber;
selectively attaching a dispensing assembly to the primary opening to cover the primary opening; and
selectively attaching a cap member to the dispensing assembly to cover the secondary opening, where the container, the dispensing assembly, and the cap member define a closed product chamber when the dispensing assembly and cap member are selectively attached to the container;
introducing base material into the product chamber through the secondary opening; and
operating the dispensing assembly to dispense the base material from the product chamber through the primary opening.

20. A method as recited in claim 19, further comprising the steps of:
introducing additive material into the product chamber through the secondary opening; and
mixing the additive material with the base material in the product chamber to form a final mixture; and
operating the dispensing assembly to dispense the final mixture from the product chamber through the primary opening.

21. A method as recited in claim 20, in which:
the base material is liquid; and
the additive material is not liquid.

22. A method as recited in claim 20, further comprising step of securing the additive material to the dispensing assembly outside of the product chamber to configure the dispensing assembly in a storage configuration.

23. A method as recited in claim 22, further comprising the steps of:
forming an additive material cavity in the container; and
arranging the additive material within the additive material cavity to arrange the dispensing assembly in the storage configuration.

24. A method as recited in claim 22, further comprising the step of attaching a cover member to the container to cover the additive material cavity when the dispensing assembly is in the storage configuration.

25. A method as recited in claim 22, further comprising the step of arranging the additive material within an additive material package when the dispensing system is in a storage configuration.

26. A method as recited in claim 20, in which the step of providing the additive material comprises the steps of providing a plurality of tablets of additive material.
